(19) United States
(12) Patent Application Publication
(10) Pub. No.: US 2026/0301150 A1
(43) Pub. Date: Oct. 1, 2026

(54) Intelligent Identification Method and System for Aging Degree of Porcelain Glaze

(71) Applicant: Hangzhou Weipaitang Cultural Creative Co. Ltd, Hangzhou (CN)

(72) Inventors: Xiuyun HU, Hangzhou (CN); Dashun CHENG, Hangzhou (CN); Zewen XU, Hangzhou (CN); Zhiqiang TAN, Hangzhou (CN)

(73) Assignee: Hangzhou Weipaitang Cultural Creative Co. Ltd, Hangzhou (CN)

(21) Appl. No.: 19/561,657

(22) Filed: Mar. 10, 2026

(30) Foreign Application Priority Data
Mar. 28, 2025 (CN) 202510377666.7

(51) Int. Cl. G06T 7/00; G06V 10/143; G06V 10/80

(52) U.S. Cl. CPC G06T 7/0004; G06V 10/143; G06V 10/806; G06T 2207/10121; G06T 2207/20081; G06T 2207/20084; G06T 2207/20221

(57) ABSTRACT

An intelligent identification method for an aging degree of a porcelain glaze includes: acquiring, by a multispectral imaging device, reflection characteristics of a target porcelain in a visible light band and a near-infrared band; processing an original image, and generating a standardized to-be-identified porcelain image, including a full-view image or a close-up image; inputting the image into a pre-trained target model, acquiring a target value of aging degree classification of each glaze region, and determining an aging degree classification result of the target porcelain; fusing the result with trace element data detected by X-ray fluorescence (XRF) spectroscopy, and generating an identification report including age dating and glaze preservation state evaluation. In this way, the intelligent and accurate identification of the aging degree of the porcelain glaze is achieved.

### CROSS REFERENCE TO THE RELATED APPLICATIONS

This application is based upon and claims priority to Chinese Patent Application No. 202510377666.7, filed on Mar. 28, 2025, the entire contents of which are incorporated herein by reference.

### TECHNICAL FIELD

The present disclosure relates to the field of artificial intelligence (AI), and in particular to an intelligent identification method and system for an aging degree of a porcelain glaze.

### BACKGROUND

Traditional identification of the aging degree of porcelain glazes mainly relies on an expert’s experience and limited instrumental detection, and has strong subjectivity, low efficiency, great influence of human factors on the accuracy, and other problems. Expert identification may yield different conclusions due to differences in personal knowledge and experience, and it is hard to make an accurate determination for some complex situations. Instrumental detection can often only provide single-dimensional data and cannot comprehensively evaluate the aging degree of porcelain glazes. Therefore, an objective, accurate and efficient intelligent identification method is urgently needed to meet the growing demand in the field of porcelain identification.

### SUMMARY

An objective of the present disclosure is to provide an intelligent identification method and system for an aging degree of a porcelain glaze.

In a first aspect, an embodiment of the present disclosure provides an intelligent identification method for an aging degree of a porcelain glaze, including:

acquiring, by a multispectral imaging device, reflection characteristics of a target porcelain in a visible light band and a near-infrared band, performing glaze reflection suppression processing on an acquired original image, and generating a standardized to-be-identified porcelain image; where, the to-be-identified porcelain image is a porcelain image of the target porcelain in a preset image type, and the preset image type includes a full-view image or a close-up image;

loading the to-be-identified porcelain image into a pre-trained target glaze aging degree identification model, and acquiring a target glaze aging degree value of an aging degree classification result of each glaze region in a porcelain image output by the target glaze aging degree identification model;

determining a target aging degree classification result of the target porcelain according to the target glaze aging degree value of the aging degree classification result of each glaze region in the porcelain image; and

performing spatiotemporal alignment and fusion according to the target aging degree classification result and trace element data detected by X-ray fluorescence (XRF) spectroscopy, and generating a porcelain glaze aging degree identification report including an age dating result and glaze preservation state evaluation.

In a second aspect, an embodiment of the present disclosure provides a server system, including a server, where the server is configured to implement the method in the first aspect.

Compared with the prior art, the intelligent identification method for an aging degree of a porcelain glaze and the system according to the present disclosure have the following beneficial effects. Reflection characteristics of a target porcelain in a visible light band and a near-infrared band are acquired by a multispectral imaging device, and an original image is processed to generate a standardized to-be-identified porcelain image, including a full-view image or a close-up image. The image is input into a pre-trained target model to acquire a target value of aging degree classification of each glaze region, and then an aging degree classification result of the target porcelain is determined. Finally, the result is fused with trace element data detected by X-ray fluorescence (XRF) spectroscopy, and an identification report including age dating and glaze preservation state evaluation is generated. In this way, the intelligent and accurate identification of the aging degree of the porcelain glaze is achieved.

### BRIEF DESCRIPTION OF THE DRAWINGS

In order to more clearly illustrate the technical solutions in the embodiments of the present disclosure, a brief introduction to the drawings required for the embodiments will be provided below. It should be understood that the drawings below only show some embodiments of the present disclosure, and therefore should not be regarded as limiting the scope of the present disclosure. Those of ordinary skill in the art may obtain other relevant drawings based on these drawings without creative efforts.

FIG. 1 is a schematic flowchart of an intelligent identification method for an aging degree of a porcelain glaze according to an embodiment of the present disclosure; and

FIG. 2 is a schematic block diagram of a computer device according to an embodiment of the present disclosure.

### DETAILED DESCRIPTION OF THE EMBODIMENTS

To make the objectives, technical solutions, and advantages of the embodiments of the present disclosure clearer, the technical solutions in the embodiments of the present disclosure are clearly and completely described below with reference to the drawings in the embodiments of the present disclosure. Apparently, the described embodiments are merely some rather than all of the embodiments of the present disclosure. Generally, components of the embodiments of the present disclosure described and shown in the drawings may be arranged and designed in various manners.

The specific implementations of the present disclosure will be described in detail below with reference to the drawings.

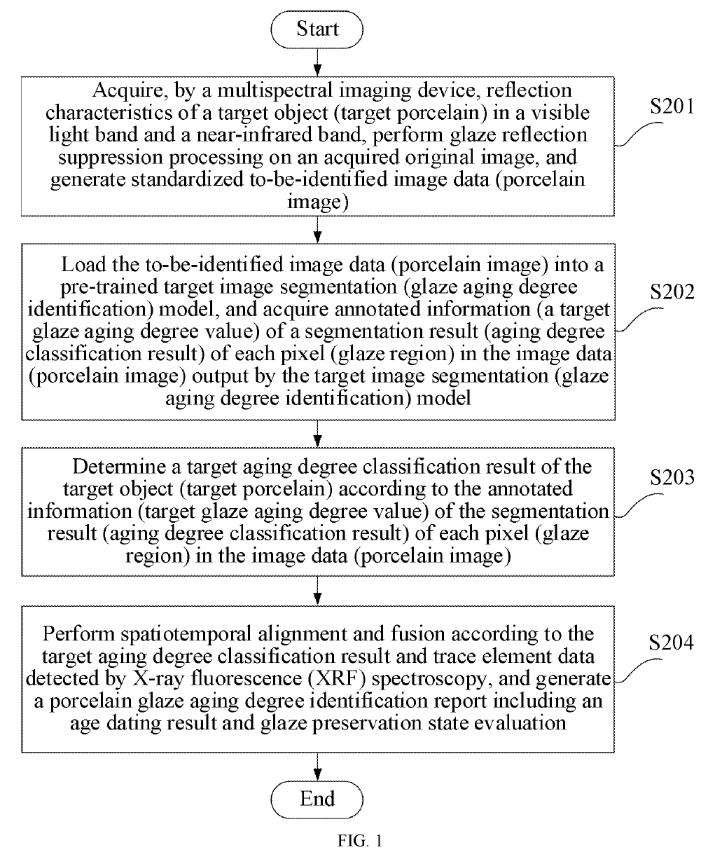

FIG. 1 is a schematic flowchart of an intelligent identification method for an aging degree of a porcelain glaze provided by an embodiment of the present disclosure to solve the aforementioned technical problems in the background art, and the intelligent identification method for an aging degree of a porcelain glaze is described in detail below.

S201. A multispectral imaging device acquires reflection characteristics of a target porcelain in a visible light band and a near-infrared band, glaze reflection suppression processing is performed on an acquired original image, and a standardized to-be-identified porcelain image is generated, where, the to-be-identified porcelain image is a porcelain image of the target porcelain in a preset image type, and the preset image type includes a full-view image or a close-up image.

S202. The to-be-identified porcelain image is loaded into a pre-trained target glaze aging degree identification model, and a target glaze aging degree value of an aging degree classification result of each glaze region in a porcelain image output by the target glaze aging degree identification model is acquired.

S203. A target aging degree classification result of the target porcelain is determined according to the target glaze aging degree value of the aging degree classification result of each glaze region in the porcelain image.

S204. Spatiotemporal alignment and fusion are performed according to the target aging degree classification result and trace element data detected by X-ray fluorescence (XRF) spectroscopy, and a porcelain glaze aging degree identification report including an age dating result and glaze preservation state evaluation is generated.

In the embodiment of the present disclosure, exemplarily, a server controls the multispectral imaging device to perform image acquisition on target porcelain. Assuming that the target porcelain is a blue and white porcelain vase of the Ming Dynasty, the multispectral imaging device scans it in the visible light band and the near-infrared band to acquire the reflection characteristics of the target porcelain in these bands. During the acquisition process, the device captures the blue and white porcelain vase from different angles and distances to ensure comprehensive capture of its surface characteristics. For example, the device first captures the vase from the top to acquire the image of the top of the vase body, then captures the main part of the vase body from the side from different angles, and takes close-up shots of detail parts such as the neck and base of the vase. The acquired original images have the problem of glaze reflection, which will affect the accuracy of subsequent identification. After receiving the original images, the server immediately performs glaze reflection suppression processing on them. Taking a region with severe reflection on the vase body as an example, the server analyzes the pixel value distribution of the region through a specific algorithm and identifies high-brightness pixels in the reflective part. Then, according to the pixel characteristics of a surrounding normal region, the server adjusts the pixel values of the reflective region to reduce its brightness and make it more consistent with the brightness of the surrounding region. After processing of these images, the server generates a standardized to-be-identified porcelain image. The preset image type here includes a full-view image or a close-up image. For this blue and white porcelain vase, the server generates its full-view image to fully display the shape, decorative patterns, and other information of the vase body. The server also generates close-up images of some key parts, such as a region with typical decorative patterns on the vase body and a region with obvious changes in the glaze, so as to conduct a more accurate aging degree analysis subsequently. The server loads the generated to-be-identified porcelain image into the pre-trained target glaze aging degree identification model. Assuming that the images of the target porcelain include a full-view image and a plurality of close-up images, the server inputs these images into the model in turn. After receiving the images, the model analyzes and processes them. For the full-view image, the model first identifies the general outline and the overall glaze characteristics of the porcelain, and determines the overall color, glossiness, and other conditions of the glaze. Taking the full-view image of the blue and white porcelain vase as an example, the model can detect the overall color distribution of the glaze on the vase body and whether there is uneven color. For the close-up images, the model analyzes the characteristics of each glaze region in more detail. For example, in a close-up image with a craze, the model detects the density and shape of the craze and analyzes the color change at the craze. Meanwhile, it observes the distribution characteristics of micro-bubbles, including the size, quantity, and distribution law of the bubbles. After the analysis and processing, the model finally outputs the target glaze aging degree values of the aging degree classification results of each glaze region in the porcelain image. For example, for a certain glaze region on the main part of the blue and white porcelain vase, the aging degree target value output by the model may indicate that the region is in a moderate aging state, while for a small region at the vase neck, the output target value shows that its aging degree is mild. After receiving the target glaze aging degree values of the aging degree classification results of each glaze region output by the model, the server conducts a comprehensive analysis of these values to determine the target aging degree classification result of the target porcelain. For this blue and white porcelain vase, the server counts the area proportion of the glaze regions with different aging degree classification results. Assuming that the aging degree target values of most regions of the vase body show moderate aging, and only a small number of regions show mild and severe aging, the server calculates a comprehensive aging degree score according to the area weight of each region. Then, according to the preset aging degree classification criteria, the server acquires the classification result corresponding to the comprehensive score. For example, if the comprehensive score falls within the range of moderate aging, the server determines that the target aging degree classification result of this blue and white porcelain vase is moderate aging. After determining the target aging degree classification result of the target porcelain, the server acquires the trace element data detected by XRF spectroscopy. It is assumed that XRF spectroscopy analysis has been carried out on this blue and white porcelain vase, and the analysis data shows the types and contents of various trace elements in the porcelain. The server performs spatiotemporal alignment and fusion of the target aging degree classification result and the trace element data. Taking the blue and white porcelain vase as an example, the server analyzes the changes in the content of trace elements corresponding to regions with different aging degrees. For example, when finding that the content of some trace elements in the moderate aging region is different from that in the mild aging region, the server further studies the relationship between such changes and the age and preservation state of the porcelain. Through the comprehensive analysis of the target aging degree classification result and the trace element data, the server generates the porcelain glaze aging degree identification report including the age dating result and the glaze preservation state evaluation. For this blue and white porcelain vase of the Ming Dynasty, the report infers the approximate age range of the porcelain and evaluates the preservation state of its glaze, such as the integrity of the glaze and whether there are obvious damage or repair traces. Meanwhile, the report will also give some suggestions on the protection and collection of the porcelain to help collectors better preserve and manage the porcelain.

In the embodiment of the present disclosure, the target glaze aging degree identification model is acquired through training as follows, and can be implemented according to the following example.

An initial glaze aging degree identification model is acquired, where the initial glaze aging degree identification model includes a first glaze recognition model and at least one second glaze recognition model; each first image instance of the first glaze recognition model includes a porcelain image of the target porcelain in the full-view image; and each second image instance of the second glaze recognition model includes a porcelain image of the target porcelain in the close-up image.

A first aging feature mapping parameter of the first glaze recognition model and a second aging feature mapping parameter of each second glaze recognition model upon completion of a current training stage are acquired.

For each second glaze recognition model, a first directional parameter set of the first aging feature mapping parameter for fusion and a second directional parameter set of the second aging feature mapping parameter for fusion are determined according to a direction consistency between a first parameter update direction and a second parameter update direction upon completion of each training stage of a latest target training stage, where, the first parameter update direction is a model parameter update direction of the first aging feature mapping parameter of a first feature mapping component, and the second parameter update direction is a model parameter update direction of the second aging feature mapping parameter of a second feature mapping component.

For each second glaze recognition model, the first directional parameter set upon completion of the current training stage is fused with the second directional parameter set of the second glaze recognition model, and the second aging feature mapping parameter corresponding to a next training stage is acquired. One training iteration is performed on the second glaze recognition model based on the acquired second aging feature mapping parameter and each second image instance of the second glaze recognition model, and the second aging feature mapping parameter upon completion of the next training stage is acquired.

The second directional parameter set of each second glaze recognition model upon completion of the next training stage is fused with the first directional parameter set of the first glaze recognition model upon completion of the current training stage, and the first aging feature mapping parameter corresponding to the next training stage is acquired. One training iteration is performed on the first glaze recognition model based on the acquired first aging feature mapping parameter and each first image instance, and the first aging feature mapping parameter upon completion of the next training stage is acquired.

The first glaze recognition model upon completion of a last training stage is determined as a first glaze aging degree identification model, and the second glaze recognition model upon completion of the last training stage is determined as a second glaze aging degree identification model.

A glaze aging degree identification model including a feature extraction component corresponding to each image type of the preset image type from the first glaze aging degree identification model or the second glaze recognition model upon completion of training is determined as the target glaze aging degree identification model.

In the embodiment of the present disclosure, exemplarily, the server trains the target glaze aging degree identification model. First, the model acquires the initial glaze aging degree identification model. The initial model includes a first glaze recognition model and a plurality of second glaze recognition models. The server extracts first image instances of the first glaze recognition model from a database, which are full-view images of the target porcelain. For example, there is a batch of porcelain from different dynasties and different kilns, such as a Ru kiln porcelain plate of the Song Dynasty, a blue and white porcelain vase of the Yuan Dynasty, a famille rose porcelain bowl of the Qing Dynasty, the server acquires their complete appearance images as the first image instances. For the Ru kiln porcelain plate of the Song Dynasty, the full-view image clearly shows the shape, size, overall color and gloss, and other information of the glaze of the porcelain plate. Meanwhile, the server acquires second image instances of the second glaze recognition model, which are close-up images of the target porcelain. Still taking the Ru kiln porcelain plate of the Song Dynasty as an example, the server selects regions such as a region with a craze on the edge of the porcelain plate, a region with inscriptions on the bottom of the plate, and a region with micro-bubbles on the glaze, to take close-up images as the second image instances. These close-up images can show the microscopic characteristics of the porcelain glaze in more detail. Upon completion of the current training stage, the server acquires the first aging feature mapping parameters of the first glaze recognition model and the second aging feature mapping parameters of each second glaze recognition model. The first aging feature mapping parameters are the parameters learned by the first feature mapping component during processing of the first image instances, which reflect the mapping law of the first glaze recognition model for the porcelain aging characteristics in the full-view images. Taking the full-view image of the blue and white porcelain vase of the Yuan Dynasty as an example, the first aging feature mapping parameters can reflect the mapping relationship for the aging characteristics such as the overall color change of the vase body and the blurriness of decorative patterns. The second aging feature mapping parameters of each second glaze recognition model are learned by the second feature mapping component for the second image instances. For example, for the close-up images of the famille rose porcelain bowl of the Qing Dynasty, the second aging feature mapping parameters can reflect the mapping of local aging characteristics such as the peeling region of famille rose on the bowl wall and the degree of color fading. For each second glaze recognition model, the server determines the first directional parameter set and the second directional parameter set for fusion according to the direction consistency between the first parameter update direction and the second parameter update direction upon completion of each training stage of the latest target training stage. The first parameter update direction is the model parameter update direction of the first aging feature mapping parameters of the first feature mapping component, and the second parameter update direction is the model parameter update direction of the second aging feature mapping parameters of the second feature mapping component. The server determines the degree of consistency by comparing the consistency of these two directions, such as calculating the cosine value of the angle between them. It is assumed that the server has three second glaze recognition models, which respectively process the close-up images of different parts of the Ru kiln porcelain plate of the Song Dynasty. When comparing the first parameter update direction and the second parameter update direction, the server finds that when a certain second glaze recognition model processes the close-up image of the crazed region of the porcelain plate, the consistency between the second parameter update direction and the first parameter update direction is relatively low. The server further analyzes each texture analysis component of the second feature mapping component of the second glaze recognition model, determines the texture analysis components with low consistency as the second texture analysis components for fusion, and takes the parameters of these components as the second directional parameter set. Then, according to these second texture analysis components, the server finds the components other than the corresponding texture analysis components in the first feature mapping component, and takes the parameters of these components as the first directional parameter set. For each second glaze recognition model, the server fuses the first directional parameter set upon completion of the current training stage with the second directional parameter set of the second glaze recognition model. The server first acquires the first feature contribution degree corresponding to the first glaze recognition model and the second feature contribution degree corresponding to each second glaze recognition model, and these contribution degrees are preset or calculated according to the performance and the feature extraction capability of the model in the previous training stages. For the target second directional parameter set of the texture analysis components corresponding to the same feature level identifier in the second directional parameter set of each second feature mapping component, the server acquires the model parameter update direction of the texture analysis components upon completion of the current training stage. For example, for the second feature mapping component processing a close-up image of the famille rose porcelain bowl of the Qing Dynasty, a certain texture analysis component corresponds to a specific feature level identifier, and the server acquires the model parameter update direction of the component upon completion of the current training stage. According to these update directions, the server calculates the third feature contribution degree of each second feature mapping component, and the contribution degree has a negative correlation with the parameter update direction of the corresponding second aging feature mapping parameters. That is to say, a component with a larger change in the parameter update direction has a lower third feature contribution degree. Then, the server performs linear superposition processing on the target second directional parameter set of the texture analysis components corresponding to the same feature level identifier according to the third feature contribution degree of the corresponding second feature mapping component to acquire the first integration results corresponding to the texture analysis components corresponding to the same feature level identifier in the next training stage. The server determines the average value of the first integration results of the texture analysis components corresponding to each feature level identifier as the third directional parameter set, and then performs weighted fusion on the first directional parameter set of the first glaze recognition model upon completion of the current training stage and the third directional parameter set based on the first feature contribution degree and the second feature contribution degree to acquire the second aging feature mapping parameters corresponding to the next training stage. The server performs one training iteration on the second glaze recognition model based on the acquired second aging feature mapping parameters and each second image instance of the second glaze recognition model. For example, for a certain second glaze recognition model for processing the close-up images of the Ru kiln porcelain plate of the Song Dynasty, the server trains it by using new second aging feature mapping parameters, inputs the corresponding close-up image instances, adjusts the parameters of the model, and finally acquires the second aging feature mapping parameters upon completion of the next training stage. The server fuses the second directional parameter set of each second glaze recognition model upon completion of the next training stage and the first directional parameter set of the first glaze recognition model upon completion of the current training stage. The specific fusion process is similar to the above fusion to acquire the second aging feature mapping parameters corresponding to the next training stage, and factors such as feature contribution degree are also considered. After acquiring the first aging feature mapping parameters corresponding to the next training stage, the server performs one training iteration on the first glaze recognition model based on the parameters and each first image instance. For example, the server processes the full-view image of the blue and white porcelain vase of the Yuan Dynasty by using the new first aging feature mapping parameters, continuously adjusts the model parameters to make the model better learn the aging characteristics in the full-view images, and finally acquires the first aging feature mapping parameters upon completion of the next training stage. After iterative training in a plurality of training stages, the server determines the first glaze recognition model upon completion of the last training stage as the first glaze aging degree identification model, and the second glaze recognition model upon completion of the last training stage as the second glaze aging degree identification model. According to the preset image type, i.e., a full-view image or a close-up image, the server selects the glaze aging degree identification model including the feature extraction components corresponding to each image type of the preset image type from the first glaze aging degree identification model or the second glaze recognition model upon completion of training as the target glaze aging degree identification model. If the to-be-identified porcelain image is a full-view image, the server selects the first glaze aging degree identification model. If it is a close-up image, the server selects a corresponding second glaze aging degree identification model. In this way, the trained target glaze aging degree identification model can be used to perform subsequent intelligent identification of the aging degree of the porcelain glaze.

In the embodiment of the present disclosure, the feature mapping components of the glaze recognition models in the initial glaze aging degree identification model are provided with a same architecture, and each include a first number of texture analysis components.

The process that for each second glaze recognition model, the first directional parameter set of the first aging feature mapping parameter for fusion and the second directional parameter set of the second aging feature mapping parameter of the second glaze recognition model for fusion are determined according to the direction consistency between the first parameter update direction and the second parameter update direction upon completion of each training stage of the latest target training stage can be implemented according to the following example.

Second texture analysis components for fusion from among the texture analysis components of the second feature mapping component of the second glaze recognition model are determined according to the direction consistency between the first parameter update direction and the second parameter update direction upon completion of each training stage of the latest target training stage, and parameters of the second texture analysis components are taken as the second directional parameter set of the second aging feature mapping parameter of the second glaze recognition model for fusion.

First texture analysis components for fusion from among the texture analysis components of the first feature mapping component are determined according to the second texture analysis components, and parameters of the first texture analysis components are taken as the first directional parameter set of the first aging feature mapping parameter for fusion, where the first texture analysis components are texture analysis components other than texture analysis components corresponding to the second texture analysis components among the texture analysis components of the first feature mapping component.

In the embodiment of the present disclosure, exemplarily, the feature mapping components of each glaze recognition model of the initial glaze aging degree identification model acquired by the server have consistent architectures, each including a first number of texture analysis components. During the training process, the server needs to determine the first directional parameter set and the second directional parameter set for fusion for each second glaze recognition model. The server compares the direction consistency between the first parameter update direction and the second parameter update direction upon completion of each training stage of the latest target training stage. Taking a celadon pot of the Yue kiln of the Tang Dynasty as an example, the first glaze recognition model processes its full-view image, and the second glaze recognition model processes the image of a local crazed region on the pot body. The server calculates the parameter update direction of each texture analysis component of the first feature mapping component and the second feature mapping component at the end of each training stage. For the second glaze recognition model processing the image of the local crazed region on the pot body, the server selects the second texture analysis components for fusion according to the direction consistency. For example, the server finds that the angle between the parameter update direction of a certain texture analysis component and that of the corresponding texture analysis component of the first feature mapping component is relatively large and the consistency is relatively low in a plurality of training stages. The server determines this texture analysis component as the second texture analysis component for fusion. The server makes such determination on all texture analysis components of the second glaze recognition model, selects the components that meet the condition, and takes the parameters of these second texture analysis components as the second directional parameter set of the second aging feature mapping parameters for fusion. Then, the server finds the first texture analysis components of the first feature mapping component for fusion according to the determined second texture analysis components. Still taking the celadon pot of the Yue kiln of the Tang Dynasty as an example, the server examines each texture analysis component of the first feature mapping component, excludes the components corresponding to the second texture analysis components, and determines the remaining components as the first texture analysis components. For example, the second texture analysis components are correspondingly configured to analyze the texture characteristics of the crazes on the pot body, then the texture analysis components of the first feature mapping component that analyze other features such as the overall color and the overall shape are determined as the first texture analysis components. The server takes the parameters of these first texture analysis components as the first directional parameter set of the first aging feature mapping parameter for fusion. In this way, the server accurately determines the first directional parameter set and the second directional parameter set of each second glaze recognition model. This lays a foundation for the subsequent parameter fusion and model training iteration, helps improve the model's ability to identify the aging degree of the porcelain glaze, and thus completes the identification of the aging degree of the porcelain glaze more accurately.

In the embodiment of the present disclosure, the process that the second directional parameter set of each second glaze recognition model upon completion of the next training stage is fused with the first directional parameter set of the first glaze recognition model upon completion of the current training stage, and the first aging feature mapping parameter corresponding to the next training stage is acquired can be implemented according to the following example.

A first feature contribution degree corresponding to the first glaze recognition model and a second feature contribution degree corresponding to each second glaze recognition model are acquired.

The second directional parameter set of each second glaze recognition model upon completion of the next training stage is integrated to acquire a third directional parameter set.

Weighted fusion is performed on the first directional parameter set of the first glaze recognition model upon completion of the current training stage and the third directional parameter set based on the first feature contribution degree and the second feature contribution degree, and the first aging feature mapping parameter corresponding to the next training stage is acquired.

In the embodiment of the present disclosure, exemplarily, when the server trains each second glaze recognition model and the first glaze recognition model, it fuses the second directional parameter set of each second glaze recognition model upon completion of the next training stage with the first directional parameter set of the first glaze recognition model upon completion of the current training stage to acquire the first aging feature mapping parameters corresponding to the next training stage. First, the server acquires the first feature contribution degree corresponding to the first glaze recognition model and the second feature contribution degree corresponding to each second glaze recognition model. Taking the identification of a batch of ancient porcelain as an example, the first glaze recognition model processes the full-view images of the porcelain and grasps the overall aging characteristics of the porcelain from a macro perspective, such as the overall color and shape changes. According to its performance and ability to extract the overall aging characteristics in the previous training, the server determines a relatively high first feature contribution degree, such as 0.6. Each second glaze recognition model processes the close-up images of the porcelain and analyzes the local aging characteristics in depth, such as the details of crazes and the distribution of bubbles. The server determines different second feature contribution degrees for each second glaze recognition model according to factors such as the accuracy of their extraction of different local features. For example, the second feature contribution degrees of the three second glaze recognition models are set to 0.1, 0.15, and 0.15, respectively. Then, the server integrates the second directional parameter sets of each second glaze recognition model upon completion of the next training stage to acquire a third directional parameter set. Assuming that the three second glaze recognition models respectively process the close-up images of the rim, the body, and the base of the porcelain, upon completion of the next training stage, the server integrates the corresponding parameters in the second directional parameter set of each model. For example, for the parameters of the texture analysis component, the server calculates the average value or weighted average value of the parameters of the component of each model, and finally acquires the third directional parameter set. Finally, the server performs weighted fusion on the first directional parameter set of the first glaze recognition model upon completion of the current training stage and the third directional parameter set based on the first feature contribution degree and the second feature contribution degree. The server multiplies the first directional parameter set by the first feature contribution degree of 0.6, multiplies the third directional parameter set by the sum of the three second feature contribution degrees of 0.4, and then sums up the two results to acquire the first aging feature mapping parameters corresponding to the next training stage. Through such a fusion method, the server integrates the overall features grasped by the first glaze recognition model and the local features analyzed by each second glaze recognition model, such that the first aging feature mapping parameters in the next training stage can reflect the aging characteristics of the porcelain more comprehensively and accurately, thereby improving the accuracy of the model in identifying the aging degree of the porcelain glaze.

In the embodiment of the present disclosure, the process that the second directional parameter set of each second glaze recognition model upon completion of the next training stage is integrated to acquire a third directional parameter set can be implemented according to the following example.

For the target second directional parameter set of the texture analysis components corresponding to the same feature level identifier in the second directional parameter set of each second feature mapping component, the target second directional parameter set of each second glaze recognition model upon completion of the next training stage is integrated to acquire a first integration result corresponding to the texture analysis component corresponding to the same feature level identifier in the next training stage.

The first integration results of the texture analysis components corresponding to each feature level identifier are integrated to acquire the third directional parameter set.

In the embodiment of the present disclosure, exemplarily, the server performs operations in specific steps in the process of integrating the second directional parameter sets of each second glaze recognition model upon completion of the next training stage to acquire the third directional parameter set. The server processes a plurality of second glaze recognition models, and the second feature mapping component of each model has its own second directional parameter set. Taking the identification of an official kiln porcelain bowl of the Song Dynasty as an example, it is assumed that the three second glaze recognition models respectively process the close-up images of the rim, the body, and the base of the porcelain bowl. The server focuses on the target second directional parameter set of the texture analysis components corresponding to the same feature level identifier in the second directional parameter set of each second feature mapping component. For example, for the feature level identifier for analyzing glaze crazing texture, the three second glaze recognition models each include corresponding texture analysis components, whose parameters form the target second directional parameter set. The server integrates the target second directional parameter sets of the three models upon completion of the next training stage. For the target second directional parameter sets for processing crazing texture of the rim, the body, and the base of the porcelain bowl, the server adopts the method of calculating the average value. If the corresponding parameters are 0.2, 0.3, and 0.25 for the rim model, the body model, and the base model, respectively, the average value is (0.2+0.3+0.25)÷3=0.25. 0.25 is the first integration result corresponding to the texture analysis component corresponding to the same feature level identifier (for analyzing glaze crazing texture) in the next training stage. The server performs such an operation on the texture analysis components corresponding to each feature level identifier. In addition to glaze crazing texture, there are also texture analysis components corresponding to different feature level identifiers for analyzing bubble distribution, color change, etc., and the server calculates their respective first integration results separately according to the above method. The server integrates the first integration results of the texture analysis components corresponding to each feature level identifier to acquire the third directional parameter set. For the first integration results of analyzing different features, the server performs integration again. For example, the first integration results of analyzing features such as crazing texture, bubble distribution, and color change are processed according to a certain rule (such as calculating the average value or weighted average again) to finally form the third directional parameter set. Through such an integration process, the server effectively integrates the information of each second glaze recognition model for different close-up images and different feature levels, such that the third directional parameter set can comprehensively reflect the training results of each second glaze recognition model. This lays a foundation for subsequent fusion with the first directional parameter set to acquire more accurate first aging feature mapping parameters corresponding to the next training stage, thereby improving the performance of the porcelain glaze aging degree identification model.

In the embodiment of the present disclosure, the process that the target second directional parameter set of each second glaze recognition model upon completion of the next training stage is integrated to acquire a first integration result corresponding to the texture analysis component corresponding to the same feature level identifier in the next training stage can be implemented according to the following example.

The model parameter update direction of each second aging feature mapping parameter upon completion of the current training stage is acquired.

A third feature contribution degree of each second feature mapping component is acquired according to the model parameter update direction of each second aging feature mapping parameter upon completion of the current training stage, where the third feature contribution degree has a negative correlation with the parameter update direction of the corresponding second aging feature mapping parameter.

For the target second directional parameter set of each texture analysis component corresponding to the same feature level identifier in the second directional parameter set of each second feature mapping component, linear superposition processing is performed based on the third feature contribution degree of the corresponding second feature mapping component, and a first integration result corresponding to the texture analysis component corresponding to the same feature level identifier in the next training stage is acquired.

The process that the first integration results of the texture analysis components corresponding to each feature level identifier are integrated to acquire the third directional parameter set can be implemented according to the following example.

An average value of first integration results of texture analysis components corresponding to each feature level identifier is determined as the third directional parameter set.

In the embodiment of the present disclosure, exemplarily, the server performs operations in a specific process when integrating the target second directional parameter sets of each second glaze recognition model to acquire the first integration results and further acquire the third directional parameter set. The server acquires the model parameter update direction of each second aging feature mapping parameter upon completion of the current training stage. Taking the identification of a blue and white porcelain vase of the Ming Dynasty as an example, the three second glaze recognition models respectively process the close-up images of the rim, the body, and the base. After the end of the current training stage, the server analyzes the change of the second aging feature mapping parameter of each model to determine its parameter update direction. For example, for the model processing the local part of the rim, its second aging feature mapping parameter changes from value A to value B in the current stage, and the server determines the update direction of the model parameter by methods such as calculating the difference between the two values. The server acquires the third feature contribution degree of each second feature mapping component according to the model parameter update direction of each second aging feature mapping parameter upon completion of the current training stage. Since the third feature contribution degree has a negative correlation with the parameter update direction of the corresponding second aging feature mapping parameter, if the update direction of a certain second aging feature mapping parameter changes greatly, it indicates that the learning of the model in this stage fluctuates significantly and has low stability, and the third feature contribution degree is relatively low. For example, if the model parameter update direction of the model processing the local part of the body changes drastically, the server assigns a low third feature contribution degree to it, such as 0.2. If the parameter update of the model processing the local part of the base is stable, the server assigns a high third feature contribution degree to it, such as 0.8. For the target second directional parameter set of the texture analysis components corresponding to the same feature level identifier in the second directional parameter set of each second feature mapping component, the server performs linear superposition processing based on the third feature contribution degree of the corresponding second feature mapping component. For example, for the texture analysis components corresponding to the feature level identifier for analyzing local glaze color change of the blue and white porcelain vase, the target second directional parameter sets of the rim, body, and base models are 0.3, 0.4 and 0.5, respectively, and the corresponding third feature contribution degrees are 0.3, 0.2 and 0.8, respectively. The server performs linear superposition: 0.3×0.3+0.4×0.2+0.5×0.8=0.53, and 0.53 is the first integration result corresponding to the texture analysis components corresponding to the same feature level identifier in the next training stage. The server integrates the first integration results of the texture analysis components corresponding to each feature level identifier to acquire the third directional parameter set. The server calculates the average value of the first integration results of the texture analysis components corresponding to different feature level identifiers (such as for analyzing glaze color change and crazing density). Assuming that the first integration results with the three different feature level identifiers are 0.53, 0.6, and 0.55, respectively, the server calculates the average value as (0.53+0.6+0.55)÷3=0.56, and determines 0.56 as the third directional parameter set. Through such operations, the server comprehensively integrates the information of each second glaze recognition model, providing more accurate data for subsequent fusion with the first directional parameter set, thereby improving the performance of the porcelain glaze aging degree identification model.

In the embodiment of the present disclosure, the process that for each second glaze recognition model, a first directional parameter set of the first aging feature mapping parameter for fusion and a second directional parameter set of the second aging feature mapping parameter for fusion are determined according to a direction consistency between a first parameter update direction and a second parameter update direction upon completion of each training stage of a latest target training stage can be implemented according to the following example.

If the direction consistency between the first parameter update direction and the second parameter update direction upon completion of each training stage of the latest target training stage does not exceed the preset consistency threshold, the feature selection matrix of the second glaze recognition model upon completion of the current training stage is updated to acquire the feature selection matrix corresponding to the next training stage. The feature selection matrix is configured to indicate the second directional parameter set of the second aging feature mapping parameter of the second glaze recognition model for fusion, and the feature selection matrix corresponding to a first training stage is a preset feature selection matrix.

The first directional parameter set of the first aging feature mapping parameter for fusion and the second directional parameter set of the second aging feature mapping parameter of the second glaze recognition model for fusion are determined according to the feature selection matrix corresponding to the next training stage, where the first directional parameter set is a parameter set of the first aging feature mapping parameter excluding a parameter corresponding to the second directional parameter set.

In the embodiment of the present disclosure, exemplarily, when processing each second glaze recognition model, the server determines the directional parameter sets for fusion according to the direction consistency between the first parameter update direction and the second parameter update direction. Taking the identification of a famille rose porcelain vase of the Qing Dynasty as an example, the server has a plurality of second glaze recognition models for respectively processing the close-up images of different parts such as the neck, the body, and the base of the porcelain vase. After the completion of each training stage of the latest target training stage, the server calculates the direction consistency between the first parameter update direction and the second parameter update direction of each second glaze recognition model. It is assumed that the preset consistency threshold set by the server is 0.8. For the second glaze recognition model processing the close-up image of the neck, the server examines the direction consistency data upon completion of each training stage of the latest target training stage and finds that the direction consistency in all stages is lower than 0.8. At this time, the server updates the feature selection matrix of the second glaze recognition model upon completion of the current training stage. The feature selection matrix is like an indicator, which can clearly specify which parameters among the second aging feature mapping parameters of the second glaze recognition model are the second directional parameter set for fusion. The feature selection matrix corresponding to the first training stage is preset, for example, the parameters corresponding to some elements in the matrix are initially set as the parameters for fusion. According to the fact that the direction consistency does not exceed the threshold, the server adjusts the elements in the matrix, such as changing the value of the element originally indicating that the parameters of some texture analysis components are used for fusion, so as to acquire the feature selection matrix corresponding to the next training stage. The server determines the directional parameter sets for fusion according to the updated feature selection matrix corresponding to the next training stage. For the second glaze recognition model processing the close-up image of the neck, the server determines the corresponding parameters among the second aging feature mapping parameters as the second directional parameter set according to the new feature selection matrix. Then, the server excludes the parameters corresponding to the second directional parameter set from the first aging feature mapping parameters, and the remaining parameter set is the first directional parameter set. The same operation is also applied to other second glaze recognition models processing the close-up images of the body, the base, and other parts. In this way, the server dynamically adjusts the feature selection matrix according to the direction consistency, thereby accurately determining the first directional parameter set and the second directional parameter set for fusion. This ensures the subsequent parameter fusion and model training are more accurate, improving the performance of the porcelain glaze aging degree identification model, thereby enabling more accurate identification of the glaze aging degree of the famille rose porcelain vase of the Qing Dynasty.

In the embodiment of the present disclosure, the direction consistency between the first parameter update direction and the second parameter update direction includes a consistency coefficient between a first sub-parameter update direction and a second sub-parameter update direction of each corresponding texture analysis component in the first glaze recognition model and the second glaze recognition model.

The process that if the direction consistency between the first parameter update direction and the second parameter update direction upon completion of each training stage of the latest target training stage does not exceed the preset consistency threshold, the feature selection matrix of the second glaze recognition model upon completion of the current training stage is updated to acquire the feature selection matrix corresponding to the next training stage can be implemented according to the following example.

For each texture analysis component in each second glaze recognition model, if the consistency coefficient of the texture analysis component upon completion of each training stage of the latest target training stage does not exceed the preset consistency threshold, the texture analysis component is determined as a target texture analysis component.

A parameter corresponding to the target texture analysis component is de-selected for fusion in a feature selection matrix of the second glaze recognition model upon completion of the current training stage, and a feature selection matrix corresponding to the next training stage is acquired.

In the embodiment of the present disclosure, exemplarily, when processing the update of the feature selection matrix of the second glaze recognition model, the server operates according to the consistency coefficient between the first and the second parameter update directions. Taking the identification of a Ru kiln porcelain plate of the Song Dynasty as an example, a plurality of second glaze recognition models respectively process different close-up images of local parts such as the edge, the center, and the patterned region of the porcelain plate, while a first glaze recognition model processes the full-view image of the porcelain plate. Upon the completion of each training stage of the latest target training stage, the server calculates the consistency coefficient between the first sub-parameter update direction and the second sub-parameter update direction of each corresponding texture analysis component in the first glaze recognition model and the second glaze recognition models. For example, for the second glaze recognition model processing the edge image of the porcelain plate, one of its texture analysis components is responsible for analyzing the crazing feature of the edge glaze. The server compares the second sub-parameter update direction of the method with the first sub-parameter update direction of the texture analysis component for analyzing the overall crazing feature in the first glaze recognition model to acquire the consistency coefficient. It is assumed that the preset consistency threshold is set to 0.7. For each texture analysis component in each second glaze recognition model, the server examines its consistency coefficient upon completion of each training stage of the latest target training stage. In the second glaze recognition model processing the center image of the porcelain plate, there is a texture analysis component responsible for analyzing the bubble distribution feature of the center glaze. If the consistency coefficient of the texture analysis component is lower than 0.7 upon completion of each training stage, the server determines this texture analysis component as a target texture analysis component. The server performs operations in the feature selection matrix of the second glaze recognition model upon completion of the current training stage. The feature selection matrix originally indicates which parameters among the second aging feature mapping parameters of the second glaze recognition model are used for fusion. The server de-selects the parameters corresponding to the target texture analysis component for fusion. For example, a row of elements in the original feature selection matrix corresponds to the parameters of the texture analysis component for processing the bubble distribution feature of the center of the porcelain plate, and the value of the element indicates that this parameter is used for fusion. The server modifies the value of this element such that it no longer indicates that the parameter is used for fusion, thereby acquiring the feature selection matrix corresponding to the next training stage. Similarly, the server performs the same operation on the second glaze recognition models processing other close-up images of the porcelain plate. In this way, the server dynamically adjusts the feature selection matrix according to the consistency coefficient, and accurately determines the parameters for fusion. This provides a more accurate basis for subsequent parameter fusion and model training, improving the performance of the porcelain glaze aging degree identification model, thereby enabling more accurate identification of the glaze aging condition of the Ru kiln porcelain plate of the Song Dynasty.

In the embodiment of the present disclosure, the acquiring of the model parameter update direction of the second aging feature mapping parameter upon completion of the current training stage can be implemented according to the following example.

The first directional parameter set of the first aging feature mapping parameter upon completion of a previous training stage is fused with the second directional parameter set of the second feature mapping component upon completion of the current training stage, and a second fusion result corresponding to the current training stage is acquired.

The model parameter update direction of the second aging feature mapping parameter upon completion of the current training stage is acquired according to a deviation between the second aging feature mapping parameter upon completion of the current training stage and the second fusion result.

The acquiring of the model parameter update direction of the first aging feature mapping parameter upon completion of the current training stage includes the following step.

The model parameter update direction of the first aging feature mapping parameter upon completion of the current training stage is acquired according to a deviation between the first aging feature mapping parameter upon completion of the current training stage and the first aging feature mapping parameter upon completion of the previous training stage.

In the embodiment of the present disclosure, exemplarily, the server has a plurality of second glaze recognition models for respectively processing the close-up images of the opening, the body, and the base of a blue and white porcelain jar. For the second glaze recognition model processing the close-up image of the jar body, the server first acquires the first directional parameter set of the first aging feature mapping parameters upon completion of the previous training stage and the second directional parameter set of the second feature mapping component upon completion of the current training stage. For example, the first directional parameter set includes parameters for analyzing the overall color change, and the second directional parameter set includes parameters for analyzing the local crazing feature of the jar body. The server fuses the two sets of parameters according to a certain rule, such as the weighted average method, to acquire the second fusion result corresponding to the current training stage. The server calculates the deviation between the second aging feature mapping parameter upon completion of the current training stage and the second fusion result. If the current second aging feature mapping parameter indicates that the crazing density of the local glaze on the jar body is a certain value, while the crazing density corresponding to the second fusion result is another value, the server acquires the deviation value through calculation methods such as subtracting the two values. The server determines the model parameter update direction of the second aging feature mapping parameters upon completion of the current training stage according to the deviation. If the deviation is positive, it indicates that the current parameter value is large, and the update direction may be to reduce the parameter value. If the deviation is negative, the update direction may be to increase the parameter value. For the full-view image of the blue and white porcelain jar processed by the first glaze recognition model, the server acquires the values of the first aging feature mapping parameters upon completion of the current training stage and upon completion of the previous training stage. For example, the parameter for analyzing the overall color uniformity in the previous stage is a certain value, and the parameter changes to another value in the current stage. The server calculates the deviation between the two values and acquires the deviation value through simple numerical subtraction. The server determines the model parameter update direction of the first aging feature mapping parameters upon completion of the current training stage according to the deviation. If the current value is larger than the value in the previous stage, the update direction may be to reduce the parameter. Otherwise, the update direction is to increase the parameter. The server performs the same operation on the second glaze recognition models processing other close-up images of the blue and white porcelain jar, so as to accurately acquire the parameter update direction of each model. This provides a basis for subsequent model training iteration, thereby improving the accuracy and reliability of the porcelain glaze aging degree identification model, and enabling more accurate identification of the glaze aging degree of the blue and white porcelain jar of the Yuan Dynasty.

In the embodiment of the present disclosure, each image instance further includes the target glaze aging degree value of the aging degree classification result of each glaze region in the corresponding porcelain image. The aging degree classification result is determined according to at least two indicators selected from glaze crazing density, color change rate, and micro-bubble distribution characteristic.

For each second glaze recognition model, each training stage further includes the following implementation.

For each second feature extraction component of the second glaze recognition model, first feature extraction component parameters of each first feature extraction component in a same image type upon completion of a previous training stage are determined as updated second feature extraction component parameters of the second feature extraction component in the current training stage.

The second glaze recognition model after update of each second feature extraction component parameter and the second aging feature mapping parameter is determined as a second glaze recognition model in the current training stage, the second glaze recognition model in the current training stage is trained to meet a second training termination state according to the image instance of the second glaze recognition model, and the second glaze recognition model upon completion of the current training stage is acquired.

For the first glaze recognition model, each training stage further includes the following implementation.

For each first feature extraction component, the second feature extraction component parameters of all second feature extraction components in a same image type upon completion of the current training stage are fused, and updated first feature extraction component parameters of each first feature extraction component in a same image type are acquired.

The first glaze recognition model after update of each first feature extraction component parameter and the first aging feature mapping parameter is determined as a first glaze recognition model in the current training stage, the first glaze recognition model in the current training stage is trained to meet a first training termination state according to the image instance of the first glaze recognition model, and the first glaze recognition model upon completion of the current training stage is acquired.

In the embodiment of the present disclosure, exemplarily, when training the porcelain glaze aging degree identification model, the server performs iterative training on the first glaze recognition model and the second glaze recognition models according to the target glaze aging degree values in the image instances. Taking the identification of a blue and white porcelain vase of the Ming Dynasty as an example, the image instances cover the full-view image of the vase and the close-up images of the rim, the body, and the base. Each image instance includes the target glaze aging degree value of the aging degree classification result of each glaze region, which is determined according to at least two indicators selected from glaze crazing density, color change rate, and micro-bubble distribution characteristic. For the second glaze recognition model processing the close-up image of the rim, when its second feature extraction component is updated in the current training stage, the server directly determines the first feature extraction component parameters of each first feature extraction component of the same image type (close-up image) upon completion of the previous training stage as the updated second feature extraction component parameters of the second feature extraction component. For example, the parameters of the first feature extraction component in analyzing the overall shape feature of the rim are applied to the second feature extraction component processing the close-up image of the rim. After update of each second feature extraction component parameter and the second aging feature mapping parameter of the second glaze recognition model, the server determines the second glaze recognition model as one in the current training stage. Then, the server trains the model in this stage based on the image instances of the model, i.e., the close-up image of the rim, until the second training termination state is met, such as the prediction accuracy of the model reaching a certain threshold or the number of training times reaching a preset value, so as to acquire the second glaze recognition model upon completion of the current training stage. The same process is also applied to other second glaze recognition models processing the close-up images of the body, the base, and other parts. For the full-view image of the blue and white porcelain vase processed by the first glaze recognition model, the server updates each first feature extraction component in each training stage. The server fuses the second feature extraction component parameters of all second feature extraction components of the same image type (full-view image) upon completion of the current training stage. For example, the parameters of the second feature extraction components processing the close-up images of the rim, the body, and the base for color feature extraction upon completion of the current training stage are subjected to operations such as weighted average to acquire the updated first feature extraction component parameters of each first feature extraction component for color feature extraction. After update of each first feature extraction component parameter and the first aging feature mapping parameter of the first glaze recognition model, the server determines the first glaze recognition model as one in the current training stage. Then, the server trains the model in this stage according to the image instances of the model, i.e., the full-view image of the blue and white porcelain vase, until the first training termination state is met, such as the loss function reaching a preset value or the number of training epochs reaching a maximum value, and finally acquires the first glaze recognition model upon completion of the current training stage. Through such an interactive training method, the server continuously optimizes the first glaze recognition model and the second glaze recognition models, and improving the identification accuracy of the model for the aging degree of the porcelain glaze.

In the embodiment of the present disclosure, the first feature mapping component and each second feature mapping component are provided with a same feature mapping component architecture, and each include at least one aging texture analysis unit. Each second feature extraction component of the second glaze recognition model includes a feature extraction unit in one-to-one correspondence with the aging texture analysis unit of the second feature mapping component in the second glaze recognition model.

The process that the second glaze recognition model in the current training stage is trained to meet a second training termination state according to the image instance of the second glaze recognition model can be implemented according to the following example.

For each aging texture analysis unit of the second glaze recognition model in the current training stage, feature information output by the corresponding feature extraction unit of each second feature extraction component of the second glaze recognition model is integrated, and a first integrated feature corresponding to the aging texture analysis unit is acquired.

For each aging texture analysis unit of the second glaze recognition model in the current training stage, according to each reference feature identifier corresponding to the aging texture analysis unit upon completion of the previous training stage, the first integrated feature corresponding to the aging texture analysis unit is optimized via gated fusion, and the first integrated feature of the aging texture analysis unit before optimization and the first integrated feature after optimization are integrated to acquire a second integrated feature corresponding to the aging texture analysis unit.

The second integrated feature corresponding to a first aging texture analysis unit is determined as a mapping result of the first aging texture analysis unit. For a non-first aging texture analysis unit, feature mapping is performed according to the second integrated feature corresponding to the non-first aging texture analysis unit and a mapping result of a previous aging texture analysis unit, and a mapping result of the non-first aging texture analysis unit is acquired.

A predicted aging degree classification result of each glaze region in the corresponding porcelain image of the image instance is acquired according to a mapping result of a last aging texture analysis unit, and each second feature extraction component parameter and the second aging feature mapping parameter of the second glaze recognition model in the current training stage are optimized according to a deviation between the predicted aging degree classification result of each glaze region and the target glaze aging degree value.

The reference feature identifier corresponding to each aging texture analysis unit is acquired by performing feature grouping on mapping features output by the corresponding aging texture analysis unit for glaze regions with a same aging degree classification result in each first image instance.

In the embodiment of the present disclosure, exemplarily, when training the second glaze recognition model, the server trains the model in the current training stage to meet the second training termination state based on the image instances. Taking the identification of a secret-color porcelain bowl of the Tang Dynasty as an example, the first feature mapping component and the second feature mapping component have the same structure, both including aging texture analysis units, and the second feature extraction component is provided with corresponding feature extraction units. The server performs feature information integration for each aging texture analysis unit of the second glaze recognition model in the current training stage. For example, the second glaze recognition model processing the close-up image of the rim is provided with three aging texture analysis units for analyzing crazing texture, color texture, and bubble distribution texture, respectively. Its second feature extraction component is provided with corresponding feature extraction units for extracting feature information of crazing, color, and bubble distribution of the rim, respectively. The server integrates the feature information output by each feature extraction unit corresponding to the same aging texture analysis unit. For the aging texture analysis unit for analyzing crazing texture, the server integrates the information output by the feature extraction units for crazing features of the rim captured from different angles to acquire the first integrated feature corresponding to the aging texture analysis unit. The server optimizes the first integrated feature of each aging texture analysis unit. Each aging texture analysis unit has corresponding reference feature identifiers upon completion of the previous training stage, and these identifiers are acquired by performing feature grouping on the mapping features output by the corresponding aging texture analysis unit for the glaze regions with the same aging degree classification result in the first image instance. For example, for the aging texture analysis unit for analyzing color texture, the server optimizes the first integrated feature of the unit by adopting gated fusion according to the reference feature identifiers acquired in the previous stage. Gated fusion is like an intelligent switch, which selectively enhances or weakens certain parts of the first integrated feature according to the reference feature identifiers. After optimization, the server integrates the first integrated features before and after optimization again to acquire the second integrated feature corresponding to the aging texture analysis unit. The server determines the mapping result of the first aging texture analysis unit. Taking the aging texture analysis unit for analyzing the crazing texture as an example, its corresponding second integrated feature is directly determined as the mapping result of the unit. For a non-first aging texture analysis unit, such as the unit for analyzing the color texture, the server performs feature mapping according to its corresponding second integrated feature and the mapping result of the previous aging texture analysis unit (crazing texture analysis unit). The features of the two are correlated and transformed through a specific mapping function to acquire the mapping result of the non-first aging texture analysis unit. In this way, the feature mapping of all aging texture analysis units is completed. The server acquires the predicted aging degree classification results of each glaze region in the image instance (the close-up image of the rim) according to the mapping result of the last aging texture analysis unit. The server compares these predicted results with the preset target glaze aging degree values in the image instance and calculates the deviation. For example, a certain region of the rim is predicted to be mildly aged, while the target value shows moderate aging, and the server optimizes each second feature extraction component parameter and the second aging feature mapping parameter of the second glaze recognition model in the current training stage according to the deviation. By adjusting the parameters, the model can predict the aging degree more accurately in subsequent training. The server repeats the above process continuously to train the second glaze recognition models processing other close-up images of local parts such as the body and the base until the second training termination state is met, such as the deviation between the predicted result and the target value being within an acceptable range or the preset number of training epochs being reached. This improves the accuracy of the second glaze recognition model in identifying the aging degree of the local glaze of the secret-color porcelain bowl of the Tang Dynasty.

In the embodiment of the present disclosure, according to the reference feature identifier upon completion of the previous training stage, the first integrated feature corresponding to the aging texture analysis unit is optimized via gated fusion can be implemented according to the following example.

A standardization operation is performed via gated fusion according to a reference feature identifier upon completion of the previous training stage, the first integrated feature corresponding to the aging texture analysis unit, and a number of texture analysis components in the aging texture analysis unit, and a fourth feature contribution degree is acquired.

The first integrated feature corresponding to the aging texture analysis unit is weighted based on the fourth feature contribution degree, and a first integrated feature after optimization is obtained.

In the embodiment of the present disclosure, exemplarily, when training the second glaze recognition model, the server optimizes the first integrated feature corresponding to the aging texture analysis unit. Taking the identification of an official kiln porcelain plate of the Song Dynasty as an example, the server performs optimization operations on the first integrated feature of each aging texture analysis unit in the second glaze recognition model processing the close-up image of the porcelain plate. The server performs optimization for a certain aging texture analysis unit of the second glaze recognition model in the current training stage, such as the aging texture analysis unit for analyzing the local crazing texture of the porcelain plate. The unit has reference feature identifiers upon completion of the previous training stage, and these identifiers are acquired by performing feature grouping on the mapping features output by the corresponding aging texture analysis unit for the glaze regions with the same aging degree classification result in the first image instance. At this time, the server has acquired the first integrated feature corresponding to the aging texture analysis unit and the number of texture analysis components in the unit. The server performs standardization operation by adopting gated fusion to acquire a fourth feature contribution degree. Gated fusion is like an intelligent filter, which performs calculation according to the reference feature identifiers, the first integrated feature, and the number of texture analysis components. Assuming that the aging texture analysis unit for analyzing the crazing texture has 3 texture analysis components, the reference feature identifiers of the previous stage indicate the correlation between a certain crazing mode and the aging degree, and the first integrated feature includes various feature information of the current local crazing of the porcelain plate. The server integrates and standardizes the information through a specific algorithm to acquire the fourth feature contribution degree. This contribution degree reflects the importance of each feature in the aging texture analysis unit in the current optimization process. The server weights the first integrated feature corresponding to the aging texture analysis unit by using the acquired fourth feature contribution degree. If the fourth feature contribution degree shows that a certain crazing feature has a greater impact on the identification of the aging degree, the server increases the weight of the feature in the first integrated feature. Otherwise, the server reduces the weight. For example, if the fourth feature contribution degree indicates that the crazing density feature has a great influence on the identification of the aging degree, the server enhances the proportion of the feature in the first integrated feature. Through such weighting operation, the server acquires the first integrated feature after optimization. The server performs the same operation on the aging texture analysis units processing other texture features (such as color texture and bubble distribution texture) of the porcelain plate. In this way, the server continuously optimizes the features of each aging texture analysis unit in the second glaze recognition model, enabling the model to identify the glaze aging degree of the porcelain plate more accurately according to the close-up images of the porcelain plate and improving the performance and accuracy of the entire identification model.

In the embodiment of the present disclosure, the reference feature identifier of each aging texture analysis unit is updated as follows.

For each first image instance, the aging degree classification result corresponding to the mapping feature of each glaze region output by the aging texture analysis unit upon completion of the previous training stage is determined according to the target glaze aging degree value of the first image instance.

For each first image instance, the mapping features of each glaze region with the same aging degree classification result output by the aging texture analysis unit are integrated, and an identification processing feature of the aging texture analysis unit for the corresponding aging degree classification result of the first image instance is acquired.

For the same aging degree classification result, feature grouping is performed on the identification processing feature of the aging texture analysis unit for the aging degree classification result of each first image instance according to a preset number of categories, and a cluster center feature of each feature group in the current training stage is determined.

For each feature group, the cluster center feature of the feature group in the current training stage and a cluster center feature of the feature group in the previous training stage are integrated, and a reference feature identifier corresponding to the feature group for the aging texture analysis unit upon completion of the current training stage is acquired.

In the embodiment of the present disclosure, exemplarily, when training the porcelain glaze aging degree identification model, the server updates the reference feature identifiers of each aging texture analysis unit. Taking the identification of a batch of ancient porcelain as an example, the first image instances of the porcelain include full-view images, and each instance has a corresponding target glaze aging degree value. For each first image instance, the server analyzes the mapping features of each glaze region output by the aging texture analysis unit upon completion of the previous training stage according to the target glaze aging degree value. For example, for the first image instance of a Ru kiln porcelain plate of the Song Dynasty, its target glaze aging degree value shows that some regions are mildly aged and some are moderately aged. The server examines the mapping features output by the aging texture analysis unit for analyzing the porcelain plate in the previous stage, determines the aging degree classification result corresponding to the mapping feature of each glaze region, and determines which mapping features correspond to the mildly aged regions and which correspond to the moderately aged regions. For each first image instance, the server integrates the mapping features of each glaze region with the same aging degree classification result output by the aging texture analysis unit. Still taking the Ru kiln porcelain plate of the Song Dynasty as an example, the server integrates all the mapping features of the glaze regions corresponding to mild aging to acquire the identification processing feature of the aging texture analysis unit for the mild aging degree classification result of the porcelain plate. Similarly, the same operation is performed on the moderately aged regions to acquire the corresponding identification processing features. For the same aging degree classification result, the server performs feature grouping on the identification processing features of the aging texture analysis unit for the aging degree classification result of each first image instance according to a preset number of categories. Assuming that the preset number of categories is 3, then the server uses a clustering algorithm to divide the identification processing features corresponding to mild aging in all first image instances into 3 groups. Then the server determines the cluster center features of each group in the current training stage, and the cluster center features represent the typical situation of the features of the group. For each feature group, the server integrates the cluster center features of the feature group in the current training stage and the previous training stage. For example, the cluster center feature of a certain feature group is A in the current stage and B in the previous stage, then the server integrates A and B. Through such integration operation, the server acquires a reference feature identifier corresponding to the feature group for the aging texture analysis unit upon completion of the current training stage. The server performs such an operation on all feature groups to complete the update of the reference feature identifiers of each aging texture analysis unit. By updating the reference feature identifiers, the server enables the aging texture analysis unit to optimize the first integrated feature more accurately according to these identifiers in subsequent training, thereby improving the performance and accuracy of the porcelain glaze aging degree identification model.

In the embodiment of the present disclosure, the method is applied to a distributed collaborative training system. The first glaze recognition model is deployed in a global aggregator, and one second glaze recognition model is deployed in one local training node. The method is implemented by the global aggregator. The acquiring of the second aging feature mapping parameter of each second glaze recognition model upon completion of the current training stage can be implemented according to the following example.

A model update parameter of each second glaze recognition model sent by each local training node is received, where the model update parameter includes the second aging feature mapping parameter of each second glaze recognition model upon completion of the current training stage.

For each second glaze recognition model, after acquiring the second aging feature mapping parameter corresponding to the next training stage, the method further includes the following step.

The model update parameter of the second glaze recognition model corresponding to the next training stage is transmitted to the corresponding local training node, such that the local training node performs one training iteration on the second glaze recognition model based on the model update parameter and the corresponding second image instance, thereby acquiring the model update parameter of the second glaze recognition model upon completion of the next training stage.

In the embodiment of the present disclosure, exemplarily, in the distributed collaborative training system, the server acts as a global aggregator to execute the training of the porcelain glaze aging degree identification model. Taking the identification of a batch of ancient porcelain as an example, the first glaze recognition model is deployed in the global aggregator, and a plurality of second glaze recognition models are respectively deployed in different local training nodes. The global aggregator waits for each local training node to complete the current training stage. Each local training node is responsible for the training of one second glaze recognition model. For example, there are three local training nodes processing the close-up images of the rim, the body, and the base of the porcelain, respectively. After the training is completed, each local training node sends the model update parameters of its second glaze recognition model to the global aggregator. These model update parameters include the second aging feature mapping parameters of the second glaze recognition model upon completion of the current training stage. For example, the local training node processing the close-up image of the rim sends the mapping parameters for analyzing the aging features such as crazing and color of the glaze of the rim. The global aggregator receives the model update parameters from different local training nodes, thereby acquiring the second aging feature mapping parameters of each second glaze recognition model. The global aggregator performs operations such as parameter fusion on each second glaze recognition model to acquire the second aging feature mapping parameters corresponding to the next training stage. For the second glaze recognition model processing the close-up image of the rim, the global aggregator transmits the model update parameters including the new second aging feature mapping parameters back to the corresponding local training node. After receiving the parameters, the local training node performs one training iteration on the second glaze recognition model based on the parameters and the corresponding second image instances (the close-up images of the rim). During the iteration, the model re-learns and analyzes the glaze aging features in the close-up images of the rim according to the new parameters and adjusts its own parameters. After the training is completed, the local training node acquires the model update parameters of the second glaze recognition model upon completion of the next training stage. Similarly, the global aggregator performs the same operation on the second glaze recognition models processing the close-up images of the body, the base, and other parts, and transmits the update parameters to the corresponding local training nodes for them to continue the training iteration. Through such a distributed collaborative training method, the global aggregator and each local training node cooperate to continuously optimize the second glaze recognition models, thereby improving the accuracy of the identification of the aging degree of the porcelain glaze.

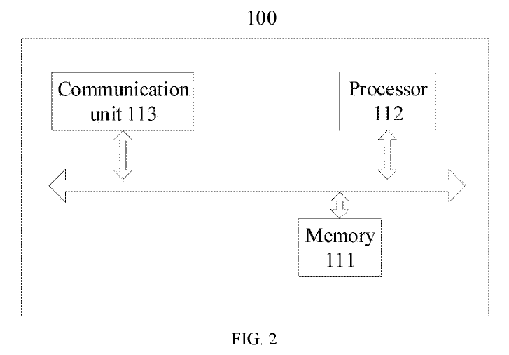

An embodiment of the present disclosure provides computer device 100. The computer device 100 includes a processor and a non-volatile memory storing a computer instruction. When the computer instruction is executed by the processor, the computer device 100 implements the intelligent identification method for an aging degree of a porcelain glaze. As shown in FIG. 2, FIG. 2 is a schematic block diagram of the computer device 100 provided by an embodiment of the present disclosure. The computer device 100 includes memory 111, processor 112, and communication unit 113. To achieve data transmission or interaction, the memory 111, the processor 112, and the communication unit 113 are electrically connected to each other directly or indirectly. For example, these elements can be electrically connected to each other through one or more communication buses or signal lines.

For the purpose of illustration, the foregoing description has been made with reference to specific embodiments. However, the illustrative discussions above are not intended to be exhaustive or to limit the present disclosure to the precise forms disclosed. Numerous modifications and variations are possible in light of the above teachings. The embodiments are chosen and described in order to best explain the principles of the present disclosure and its practical application, thereby enabling those skilled in the art to make the best use of the present disclosure and various embodiments with different modifications as are suited to the particular use contemplated.

1. An intelligent identification method for an aging degree of a porcelain glaze, comprising:
acquiring, by a multispectral imaging device, reflection characteristics of a target porcelain in a visible light band and a near-infrared band, performing glaze reflection suppression processing on an acquired original image, and generating a standardized to-be-identified porcelain image;
wherein the to-be-identified porcelain image is a porcelain image of the target porcelain in a preset image type, and the preset image type comprises a full-view image or a close-up image;
loading the to-be-identified porcelain image into a pre-trained target glaze aging degree identification model, and acquiring a target glaze aging degree value of an aging degree classification result of each glaze region in a porcelain image output by the target glaze aging degree identification model;
determining a target aging degree classification result of the target porcelain according to the target glaze aging degree value of the aging degree classification result of each glaze region in the porcelain image; and
performing spatiotemporal alignment and fusion according to the target aging degree classification result and trace element data detected by X-ray fluorescence (XRF) spectroscopy, and generating a porcelain glaze aging degree identification report comprising an age dating result and glaze preservation state evaluation;
wherein the target glaze aging degree identification model is acquired through training as follows:
acquiring an initial glaze aging degree identification model, wherein the initial glaze aging degree identification model comprises a first glaze recognition model and at least one second glaze recognition model; each first image instance of the first glaze recognition model comprises a porcelain image of the target porcelain in the full-view image; and each second image instance of the second glaze recognition model comprises a porcelain image of the target porcelain in the close-up image;
acquiring a first aging feature mapping parameter of the first glaze recognition model and a second aging feature mapping parameter of each second glaze recognition model upon completion of a current training stage;
for each second glaze recognition model, determining a first directional parameter set of the first aging feature mapping parameter for fusion and a second directional parameter set of the second aging feature mapping parameter for fusion according to a direction consistency between a first parameter update direction and a second parameter update direction upon completion of each training stage of a latest target training stage;
wherein the first parameter update direction is a model parameter update direction of the first aging feature mapping parameter of a first feature mapping component, and the second parameter update direction is a model parameter update direction of the second aging feature mapping parameter of a second feature mapping component;
for each second glaze recognition model, fusing the first directional parameter set upon completion of the current training stage with the second directional parameter set of the second glaze recognition model, and acquiring the second aging feature mapping parameter corresponding to a next training stage; and performing one training iteration on the second glaze recognition model based on the acquired second aging feature mapping parameter and each second image instance of the second glaze recognition model, and acquiring the second aging feature mapping parameter upon completion of the next training stage;
fusing the second directional parameter set of each second glaze recognition model upon completion of the next training stage with the first directional parameter set of the first glaze recognition model upon completion of the current training stage, and acquiring the first aging feature mapping parameter corresponding to the next training stage; and performing one training iteration on the first glaze recognition model based on the acquired first aging feature mapping parameter and each first image instance, and acquiring the first aging feature mapping parameter upon completion of the next training stage;
wherein the first glaze recognition model upon completion of a last training stage is determined as a first glaze aging degree identification model, and the second glaze recognition model upon completion of the last training stage is determined as a second glaze aging degree identification model; and
determining a glaze aging degree identification model comprising a feature extraction component corresponding to each image type of the preset image type from the first glaze aging degree identification model or the second glaze recognition model upon completion of training as the target glaze aging degree identification model.

2. The method according to claim 1, wherein the feature mapping components of the glaze recognition models in the initial glaze aging degree identification model are provided with a same architecture, and each comprise a first number of texture analysis components;
for each second glaze recognition model, determining the first directional parameter set of the first aging feature mapping parameter for fusion and the second directional parameter set of the second aging feature mapping parameter of the second glaze recognition model for fusion according to the direction consistency between the first parameter update direction and the second parameter update direction upon completion of each training stage of the latest target training stage comprises:
determining second texture analysis components for fusion from among the texture analysis components of the second feature mapping component of the second glaze recognition model according to the direction consistency between the first parameter update direction and the second parameter update direction upon completion of each training stage of the latest target training stage, and taking parameters of the second texture analysis components as the second directional parameter set of the second aging feature mapping parameter of the second glaze recognition model for fusion; and
determining first texture analysis components for fusion from among the texture analysis components of the first feature mapping component according to the second texture analysis components, and taking parameters of the first texture analysis components as the first directional parameter set of the first aging feature mapping parameter for fusion, wherein the first texture analysis components are texture analysis components other than texture analysis components corresponding to the second texture analysis components among the texture analysis components of the first feature mapping component.

3. The method according to claim 1, wherein the fusing the second directional parameter set of each second glaze recognition model upon completion of the next training stage with the first directional parameter set of the first glaze recognition model upon completion of the current training stage, and acquiring the first aging feature mapping parameter corresponding to the next training stage comprises:
acquiring a first feature contribution degree corresponding to the first glaze recognition model and a second feature contribution degree corresponding to each second glaze recognition model;
for a target second directional parameter set of each texture analysis component corresponding to a same feature level identifier in the second directional parameter set of each second feature mapping component, acquiring the model parameter update direction of each second aging feature mapping parameter upon completion of the current training stage;
acquiring a third feature contribution degree of each second feature mapping component according to the model parameter update direction of each second aging feature mapping parameter upon completion of the current training stage, wherein the third feature contribution degree has a negative correlation with the parameter update direction of the corresponding second aging feature mapping parameter;
for the target second directional parameter set of each texture analysis component corresponding to the same feature level identifier in the second directional parameter set of each second feature mapping component, performing linear superposition processing based on the third feature contribution degree of the corresponding second feature mapping component, and acquiring a first integration result corresponding to the texture analysis component corresponding to the same feature level identifier in the next training stage;
determining an average value of first integration results of texture analysis components corresponding to each feature level identifier as a third directional parameter set; and
performing weighted fusion on the first directional parameter set of the first glaze recognition model upon completion of the current training stage and the third directional parameter set based on the first feature contribution degree and the second feature contribution degree, and acquiring the first aging feature mapping parameter corresponding to the next training stage.

4. The method according to claim 1, wherein the direction consistency between the first parameter update direction and the second parameter update direction comprises a consistency coefficient between a first sub-parameter update direction and a second sub-parameter update direction of each corresponding texture analysis component in the first glaze recognition model and the second glaze recognition model;
for each second glaze recognition model, determining the first directional parameter set of the first aging feature mapping parameter for fusion and the second directional parameter set of the second aging feature mapping parameter for fusion according to the direction consistency between the first parameter update direction and the second parameter update direction upon completion of each training stage of the latest target training stage comprises:
for each texture analysis component in each second glaze recognition model, if the consistency coefficient of the texture analysis component upon completion of each training stage of the latest target training stage does not exceed a preset consistency threshold, determining the texture analysis component as a target texture analysis component; and de-selecting a parameter corresponding to the target texture analysis component for fusion in a feature selection matrix of the second glaze recognition model upon completion of the current training stage, and acquiring a feature selection matrix corresponding to the next training stage;
wherein the feature selection matrix is configured to indicate the second directional parameter set of the second aging feature mapping parameter of the second glaze recognition model for fusion, and the feature selection matrix corresponding to a first training stage is a preset feature selection matrix; and
determining the first directional parameter set of the first aging feature mapping parameter for fusion and the second directional parameter set of the second aging feature mapping parameter of the second glaze recognition model for fusion according to the feature selection matrix corresponding to the next training stage, wherein the first directional parameter set is a parameter set of the first aging feature mapping parameter excluding a parameter corresponding to the second directional parameter set.

5. The method according to claim 1, wherein the acquiring of the model parameter update direction of the second aging feature mapping parameter upon completion of the current training stage comprises:
fusing the first directional parameter set of the first aging feature mapping parameter upon completion of a previous training stage with the second directional parameter set of the second feature mapping component upon completion of the current training stage, and acquiring a second fusion result corresponding to the current training stage; and
acquiring the model parameter update direction of the second aging feature mapping parameter upon completion of the current training stage according to a deviation between the second aging feature mapping parameter upon completion of the current training stage and the second fusion result; and
the acquiring of the model parameter update direction of the first aging feature mapping parameter upon completion of the current training stage comprises:
acquiring the model parameter update direction of the first aging feature mapping parameter upon completion of the current training stage according to a deviation between the first aging feature mapping parameter upon completion of the current training stage and the first aging feature mapping parameter upon completion of the previous training stage.

6. The method according to claim 1, wherein each image instance further comprises the target glaze aging degree value of the aging degree classification result of each glaze region in the corresponding porcelain image;
the aging degree classification result is determined according to at least two indicators selected from glaze crazing density, color change rate, and micro-bubble distribution characteristic;
the first feature mapping component and each second feature mapping component are provided with a same feature mapping component architecture, and each comprise at least one aging texture analysis unit; and each second feature extraction component of the second glaze recognition model comprises a feature extraction unit in one-to-one correspondence with the aging texture analysis unit of the second feature mapping component in the second glaze recognition model;
for each second glaze recognition model, each training stage further comprises:
for each second feature extraction component of the second glaze recognition model, determining first feature extraction component parameters of each first feature extraction component in a same image type upon completion of a previous training stage as updated second feature extraction component parameters of the second feature extraction component in the current training stage;
determining the second glaze recognition model after update of each second feature extraction component parameter and the second aging feature mapping parameter as a second glaze recognition model in the current training stage;
for each aging texture analysis unit of the second glaze recognition model in the current training stage, integrating feature information output by the corresponding feature extraction unit of each second feature extraction component of the second glaze recognition model, and acquiring a first integrated feature corresponding to the aging texture analysis unit;
for each aging texture analysis unit of the second glaze recognition model in the current training stage, performing a standardization operation via gated fusion according to a reference feature identifier upon completion of the previous training stage, the first integrated feature corresponding to the aging texture analysis unit, and a number of texture analysis components in the aging texture analysis unit, and acquiring a fourth feature contribution degree;
weighting the first integrated feature corresponding to the aging texture analysis unit based on the fourth feature contribution degree, acquiring a first integrated feature after optimization, integrating the first integrated feature of the aging texture analysis unit before optimization and the first integrated feature after optimization, and acquiring a second integrated feature corresponding to the aging texture analysis unit;
determining the second integrated feature corresponding to a first aging texture analysis unit as a mapping result of the first aging texture analysis unit; and for a non-first aging texture analysis unit, performing feature mapping according to the second integrated feature corresponding to the non-first aging texture analysis unit and a mapping result of a previous aging texture analysis unit, and acquiring a mapping result of the non-first aging texture analysis unit; and
acquiring a predicted aging degree classification result of each glaze region in the corresponding porcelain image of the image instance according to a mapping result of a last aging texture analysis unit, and optimizing each second feature extraction component parameter and the second aging feature mapping parameter of the second glaze recognition model in the current training stage according to a deviation between the predicted aging degree classification result of each glaze region and the target glaze aging degree value, thereby acquiring the second glaze recognition model upon completion of the current training stage;
wherein the reference feature identifier corresponding to each aging texture analysis unit is acquired by performing feature grouping on mapping features output by the corresponding aging texture analysis unit for glaze regions with a same aging degree classification result in each first image instance;
for the first glaze recognition model, each training stage further comprises:
for each first feature extraction component, fusing the second feature extraction component parameters of all second feature extraction components in a same image type upon completion of the current training stage, and acquiring updated first feature extraction component parameters of each first feature extraction component in a same image type; and
determining the first glaze recognition model after update of each first feature extraction component parameter and the first aging feature mapping parameter as a first glaze recognition model in the current training stage, training the first glaze recognition model in the current training stage to meet a first training termination state according to the image instance of the first glaze recognition model, and acquiring the first glaze recognition model upon completion of the current training stage.

7. The method according to claim 6, wherein the reference feature identifier of each aging texture analysis unit is updated as follows:
for each first image instance, determining the aging degree classification result corresponding to the mapping feature of each glaze region output by the aging texture analysis unit upon completion of the previous training stage according to the target glaze aging degree value of the first image instance;
for each first image instance, integrating the mapping features of each glaze region with the same aging degree classification result output by the aging texture analysis unit, and acquiring an identification processing feature of the aging texture analysis unit for the corresponding aging degree classification result of the first image instance;
for the same aging degree classification result, performing feature grouping on the identification processing feature of the aging texture analysis unit for the aging degree classification result of each first image instance according to a preset number of categories, and determining a cluster center feature of each feature group in the current training stage; and
for each feature group, integrating the cluster center feature of the feature group in the current training stage and a cluster center feature of the feature group in the previous training stage, and acquiring a reference feature identifier corresponding to the feature group for the aging texture analysis unit upon completion of the current training stage.

8. The method according to claim 1, wherein the method is applied to a distributed collaborative training system; the first glaze recognition model is deployed in a global aggregator, and one second glaze recognition model is deployed in one local training node; the method is implemented by the global aggregator; and the acquiring of the second aging feature mapping parameter of each second glaze recognition model upon completion of the current training stage comprises:
receiving a model update parameter of each second glaze recognition model sent by each local training node, wherein the model update parameter comprises the second aging feature mapping parameter of each second glaze recognition model upon completion of the current training stage; and
for each second glaze recognition model, after acquiring the second aging feature mapping parameter corresponding to the next training stage, the method further comprises: transmitting the model update parameter of the second glaze recognition model corresponding to the next training stage to the corresponding local training node, such that the local training node performs one training iteration on the second glaze recognition model based on the model update parameter and the corresponding second image instance, thereby acquiring the model update parameter of the second glaze recognition model upon completion of the next training stage.

9. A server system, comprising a server, wherein the server is configured to implement the method according to claim 1.

10. The server system according to claim 9, wherein the feature mapping components of the glaze recognition models in the initial glaze aging degree identification model are provided with a same architecture, and each comprise a first number of texture analysis components;
for each second glaze recognition model, determining the first directional parameter set of the first aging feature mapping parameter for fusion and the second directional parameter set of the second aging feature mapping parameter of the second glaze recognition model for fusion according to the direction consistency between the first parameter update direction and the second parameter update direction upon completion of each training stage of the latest target training stage comprises:
determining second texture analysis components for fusion from among the texture analysis components of the second feature mapping component of the second glaze recognition model according to the direction consistency between the first parameter update direction and the second parameter update direction upon completion of each training stage of the latest target training stage, and taking parameters of the second texture analysis components as the second directional parameter set of the second aging feature mapping parameter of the second glaze recognition model for fusion; and
determining first texture analysis components for fusion from among the texture analysis components of the first feature mapping component according to the second texture analysis components, and taking parameters of the first texture analysis components as the first directional parameter set of the first aging feature mapping parameter for fusion, wherein the first texture analysis components are texture analysis components other than texture analysis components corresponding to the second texture analysis components among the texture analysis components of the first feature mapping component.

11. The server system according to claim 9, wherein the fusing the second directional parameter set of each second glaze recognition model upon completion of the next training stage with the first directional parameter set of the first glaze recognition model upon completion of the current training stage, and acquiring the first aging feature mapping parameter corresponding to the next training stage comprises:
acquiring a first feature contribution degree corresponding to the first glaze recognition model and a second feature contribution degree corresponding to each second glaze recognition model;
for a target second directional parameter set of each texture analysis component corresponding to a same feature level identifier in the second directional parameter set of each second feature mapping component, acquiring the model parameter update direction of each second aging feature mapping parameter upon completion of the current training stage;
acquiring a third feature contribution degree of each second feature mapping component according to the model parameter update direction of each second aging feature mapping parameter upon completion of the current training stage, wherein the third feature contribution degree has a negative correlation with the parameter update direction of the corresponding second aging feature mapping parameter;
for the target second directional parameter set of each texture analysis component corresponding to the same feature level identifier in the second directional parameter set of each second feature mapping component, performing linear superposition processing based on the third feature contribution degree of the corresponding second feature mapping component, and acquiring a first integration result corresponding to the texture analysis component corresponding to the same feature level identifier in the next training stage;
determining an average value of first integration results of texture analysis components corresponding to each feature level identifier as a third directional parameter set; and
performing weighted fusion on the first directional parameter set of the first glaze recognition model upon completion of the current training stage and the third directional parameter set based on the first feature contribution degree and the second feature contribution degree, and acquiring the first aging feature mapping parameter corresponding to the next training stage.

12. The server system according to claim 9, wherein the direction consistency between the first parameter update direction and the second parameter update direction comprises a consistency coefficient between a first sub-parameter update direction and a second sub-parameter update direction of each corresponding texture analysis component in the first glaze recognition model and the second glaze recognition model;
for each second glaze recognition model, determining the first directional parameter set of the first aging feature mapping parameter for fusion and the second directional parameter set of the second aging feature mapping parameter for fusion according to the direction consistency between the first parameter update direction and the second parameter update direction upon completion of each training stage of the latest target training stage comprises:
for each texture analysis component in each second glaze recognition model, if the consistency coefficient of the texture analysis component upon completion of each training stage of the latest target training stage does not exceed a preset consistency threshold, determining the texture analysis component as a target texture analysis component; and de-selecting a parameter corresponding to the target texture analysis component for fusion in a feature selection matrix of the second glaze recognition model upon completion of the current training stage, and acquiring a feature selection matrix corresponding to the next training stage;
wherein the feature selection matrix is configured to indicate the second directional parameter set of the second aging feature mapping parameter of the second glaze recognition model for fusion, and the feature selection matrix corresponding to a first training stage is a preset feature selection matrix; and
determining the first directional parameter set of the first aging feature mapping parameter for fusion and the second directional parameter set of the second aging feature mapping parameter of the second glaze recognition model for fusion according to the feature selection matrix corresponding to the next training stage, wherein the first directional parameter set is a parameter set of the first aging feature mapping parameter excluding a parameter corresponding to the second directional parameter set.

13. The server system according to claim 9, wherein the acquiring of the model parameter update direction of the second aging feature mapping parameter upon completion of the current training stage comprises:
fusing the first directional parameter set of the first aging feature mapping parameter upon completion of a previous training stage with the second directional parameter set of the second feature mapping component upon completion of the current training stage, and acquiring a second fusion result corresponding to the current training stage; and
acquiring the model parameter update direction of the second aging feature mapping parameter upon completion of the current training stage according to a deviation between the second aging feature mapping parameter upon completion of the current training stage and the second fusion result; and
the acquiring of the model parameter update direction of the first aging feature mapping parameter upon completion of the current training stage comprises:
acquiring the model parameter update direction of the first aging feature mapping parameter upon completion of the current training stage according to a deviation between the first aging feature mapping parameter upon completion of the current training stage and the first aging feature mapping parameter upon completion of the previous training stage.

14. The server system according to claim 9, wherein each image instance further comprises the target glaze aging degree value of the aging degree classification result of each glaze region in the corresponding porcelain image;
the aging degree classification result is determined according to at least two indicators selected from glaze crazing density, color change rate, and micro-bubble distribution characteristic;
the first feature mapping component and each second feature mapping component are provided with a same feature mapping component architecture, and each comprise at least one aging texture analysis unit; and each second feature extraction component of the second glaze recognition model comprises a feature extraction unit in one-to-one correspondence with the aging texture analysis unit of the second feature mapping component in the second glaze recognition model;
for each second glaze recognition model, each training stage further comprises:
for each second feature extraction component of the second glaze recognition model, determining first feature extraction component parameters of each first feature extraction component in a same image type upon completion of a previous training stage as updated second feature extraction component parameters of the second feature extraction component in the current training stage;
determining the second glaze recognition model after update of each second feature extraction component parameter and the second aging feature mapping parameter as a second glaze recognition model in the current training stage;
for each aging texture analysis unit of the second glaze recognition model in the current training stage, integrating feature information output by the corresponding feature extraction unit of each second feature extraction component of the second glaze recognition model, and acquiring a first integrated feature corresponding to the aging texture analysis unit;
for each aging texture analysis unit of the second glaze recognition model in the current training stage, performing a standardization operation via gated fusion according to a reference feature identifier upon completion of the previous training stage, the first integrated feature corresponding to the aging texture analysis unit, and a number of texture analysis components in the aging texture analysis unit, and acquiring a fourth feature contribution degree;
weighting the first integrated feature corresponding to the aging texture analysis unit based on the fourth feature contribution degree, acquiring a first integrated feature after optimization, integrating the first integrated feature of the aging texture analysis unit before optimization and the first integrated feature after optimization, and acquiring a second integrated feature corresponding to the aging texture analysis unit;
determining the second integrated feature corresponding to a first aging texture analysis unit as a mapping result of the first aging texture analysis unit; and for a non-first aging texture analysis unit, performing feature mapping according to the second integrated feature corresponding to the non-first aging texture analysis unit and a mapping result of a previous aging texture analysis unit, and acquiring a mapping result of the non-first aging texture analysis unit; and
acquiring a predicted aging degree classification result of each glaze region in the corresponding porcelain image of the image instance according to a mapping result of a last aging texture analysis unit, and optimizing each second feature extraction component parameter and the second aging feature mapping parameter of the second glaze recognition model in the current training stage according to a deviation between the predicted aging degree classification result of each glaze region and the target glaze aging degree value, thereby acquiring the second glaze recognition model upon completion of the current training stage;
wherein the reference feature identifier corresponding to each aging texture analysis unit is acquired by performing feature grouping on mapping features output by the corresponding aging texture analysis unit for glaze regions with a same aging degree classification result in each first image instance;
for the first glaze recognition model, each training stage further comprises:
for each first feature extraction component, fusing the second feature extraction component parameters of all second feature extraction components in a same image type upon completion of the current training stage, and acquiring updated first feature extraction component parameters of each first feature extraction component in a same image type; and
determining the first glaze recognition model after update of each first feature extraction component parameter and the first aging feature mapping parameter as a first glaze recognition model in the current training stage, training the first glaze recognition model in the current training stage to meet a first training termination state according to the image instance of the first glaze recognition model, and acquiring the first glaze recognition model upon completion of the current training stage.

15. The server system according to claim 14, wherein the reference feature identifier of each aging texture analysis unit is updated as follows:
for each first image instance, determining the aging degree classification result corresponding to the mapping feature of each glaze region output by the aging texture analysis unit upon completion of the previous training stage according to the target glaze aging degree value of the first image instance;
for each first image instance, integrating the mapping features of each glaze region with the same aging degree classification result output by the aging texture analysis unit, and acquiring an identification processing feature of the aging texture analysis unit for the corresponding aging degree classification result of the first image instance;
for the same aging degree classification result, performing feature grouping on the identification processing feature of the aging texture analysis unit for the aging degree classification result of each first image instance according to a preset number of categories, and determining a cluster center feature of each feature group in the current training stage; and
for each feature group, integrating the cluster center feature of the feature group in the current training stage and a cluster center feature of the feature group in the previous training stage, and acquiring a reference feature identifier corresponding to the feature group for the aging texture analysis unit upon completion of the current training stage.

16. The server system according to claim 9, wherein the method is applied to a distributed collaborative training system; the first glaze recognition model is deployed in a global aggregator, and one second glaze recognition model is deployed in one local training node; the method is implemented by the global aggregator; and the acquiring of the second aging feature mapping parameter of each second glaze recognition model upon completion of the current training stage comprises:
receiving a model update parameter of each second glaze recognition model sent by each local training node, wherein the model update parameter comprises the second aging feature mapping parameter of each second glaze recognition model upon completion of the current training stage; and
for each second glaze recognition model, after acquiring the second aging feature mapping parameter corresponding to the next training stage, the method further comprises: transmitting the model update parameter of the second glaze recognition model corresponding to the next training stage to the corresponding local training node, such that the local training node performs one training iteration on the second glaze recognition model based on the model update parameter and the corresponding second image instance, thereby acquiring the model update parameter of the second glaze recognition model upon completion of the next training stage.
